(19) United States
(12) Patent Application Publication
(10) Pub. No.: US 2004/0178140 A1
(43) Pub. Date: Sep. 16, 2004

(54) Filtering device

(76) Inventor: Carl-Martin Bell, Reuthingen (DE)

Correspondence Address: STRIKER, STRIKER & STENBY, 103 East Neck Road, Huntington, NY, 11743, US

(21) Appl. No.: 10/770,973

(22) Filed: Feb. 3, 2004

(30) Foreign Application Priority Data
Feb. 4, 2003 (DE) 103 04 365.9

(51) Int. Cl. B01D 29/00

(52) U.S. Cl. 210/488; 210/490

(57) ABSTRACT

A filtering device for filtering out of leukocytes from blood, blood plasma, blood components or protein solutions has a non-woven fabric, and at least one membrane having a thickness of smaller than 150 μm and a pore size smaller than 15 μm.

### BACKGROUND OF THE INVENTION

The present invention relates to a filtering device for filtering out of leucocytes from blood, blood plasma, blood components or protein solutions.

In recent years all over Europe regulations have been introduced that blood and blood components for transfusions must be depleted from leucocytes so that at most 10⁶ leucocytes per unit of blood components are retained. With these steps, damaging side effects during blood transfusions such as changes in the immune system, allergic sensibilization, virus infections, etc. can be significantly reduced. Nevertheless there is always a disease risk during transfusions of 1:500 and a death risk of 1:200000.

The major problems in blood processing nowadays include insufficient recovery of blood platelets for the production of blood platelet concentrates and the activation of blood components, or in other words cells, that lead to infection-related reactions or cytokine-related reactions of patients, which are damaging for the curing process of the patients.

V. Kratschmar on the German Anesthesiology Congress, 22-25 Jun. 2002 in Nurnberg, summarized the following reactions which are related to non-hemolytic transfusions:

1. leukocyte antibodies in patients,

2. allergic reactions of the patients due to of allergenic antibodies in donor's blood.

3. thrombocyte antibodies in patients,

4. cytokines presence leading to cell activation and to infection-related reactions of patients.

Type 1 reactions decreased strongly since the introduction of the leucocyte filtering of blood components.

Type 2 reactions are dealt with by excluding donors with allergies from blood donation.

Type 3 reactions remain constant at a low level.

Type 4 reactions are significantly increased since the leucocyte filtering of blood and its components has been introduced.

Kratchmar traced the presence of cytokines and cell activation signals to the activation of donor blood cells during the leucocyte filtering due to an interaction of the blood components with the foreign material of the filtering medium.

Pre-activated and available leucocytes cause such activation primarily in blood platelet concentrates during their storage, that normally amounts to five days at 22° C. An activation of thrombocytes by a filtering medium is a fast process leading to an increase of the tendency of the blood platelets for stickiness to one another and to blood coagulation.

In this way patients receive blood which is activated towards infection reactions and/or coagulation reactions, and then the curing process of the patients is negatively affected.

A further disadvantage of existing leucocyte filtering devices is that the filtering devices aspirate up to 10% of the donor blood, which represents a waste.

Leucocytes filtration is carried out now with fibrous or porous materials, for example non-woven fabrics, which however are relatively voluminous. This leads to great contact surfaces between the blood and the filtering material, which can cause the above described activation of the blood cells.

Alternatively, membranes with a pore size of 5-15 μm for leucocyte filtering are utilized. Such membranes are disclosed for example in U.S. Pat. No. 5,820,755. These membranes are composed of nitrocellulose. Japanese patent 3-47131 discloses membranes for the leukocyte filtering with a thickness of 0.3-0.9 mm composed of polyurethane and membranes composed of polyvinylidene fluoride and polysulfones or polyester.

### SUMMARY OF THE INVENTION

Accordingly, it is an object of the present invention to provide a leukocyte filtering device for blood, which is a further improvement of the existing devices.

More particularly, it is an object of the present invention to provide a leukocyte filtering device for blood, which causes a lower activation of blood components than the existing leukocyte filtering devices.

In keeping with these objects and with others which will become apparent herein after, one feature of present invention resides, briefly stated, in a filtering device for filtering out of leucocytes from blood, blood plasma, blood components, or protein solutions, which in accordance with the present invention, has a non-woven fabric, and at least one membrane with a thickness of smaller than 100 μm and a pore size smaller than 15 μm.

The novel features which are considered as characteristic for the present invention are set forth in particular in the appended claims. the invention itself, however, both as to its construction and its method of operation, together with additional objects and advantages thereof, will be best understood from the following description of specific embodiments.

### DESCRIPTION OF THE PREFERRED EMBODIMENTS

In accordance with the present invention, a filtering device for filtering out of leucocytes from blood, blood plasma, blood components, or protein solutions has a non-woven fabric and at least one membrane with a thickness smaller than 100 μm and the pore size smaller than 15 μm.

Moreover in front of the non-woven fabric, a membrane with a thickness of smaller than or equal to 150 μm and a pore size of greater than or equal to 15 μm is arranged.

This membrane arranged in front of the non-woven fabric and having a relatively great pore size serves for the uniform distribution of the blood. The subsequent thin non-woven fabric retains a filter cake of loose sticking leucocytes, while the following, fine-pore membrane retains individual leucocytes.

The membrane which is arranged in front of the non-woven fabric can be made of a hydrophilic material, which is easily wetted by the blood, the blood plasma or the protein solutions. The thickness of the membrane can be preferably 20-150 μm. Due to the small thickness the pressure of the blood flowing through the filtering device, caused by this membrane, can be very small.

The average pore size can be for example 15-100 μm, but can amount preferably to 15-40 μm. The distribution function of this membrane serves for using the total filter cross-section for filtering out of leucocytes.

The subsequent non-woven fabric can have a pore size of 15-50 μm. Due to this great pore size the non-woven fabric not necessarily must be composed of a hydrophilic material. The blood flows also relatively undisturbed through the non-woven fabric.

The membrane or membranes located after the non-woven fabric has/have a thickness of smaller than 150 μm, preferably 50-130 μm. The average pore size can be for example 4-14 μm, so that leucocytes can no longer pass through the pores. The smaller thrombocytes and erythrocytes are however passing through. The erythrocytes have a similar size as the leucocytes, but they are more flexible and easier to deform, so that they can readily pass through the smaller pores in contrast to the leucocytes. Also, the membrane arranged after the non-woven fabric is composed preferably of a hydrophilic material, so that no absorption of blood cells occurs, and the blood is braked in the flow only a little.

Leucocytes which do not adhere to the membrane or absorbed by it are transported back by diffusion and convection to the non-woven fabric layer. They are adsorbed in it with time due to weaker hydrophobic forces. The filter cake which is formed in this manner is permeable for blood platelets and erythrocytes and represents no significant obstacle for the blood flow.

Further advantages are provided when the membranes are composed of a biocompatible material, to avoid a rejection reaction of the blood components with the membrane surfaces. As the materials for the membranes, it is possible to use for example polysulfones, polyethersulfones, or compositions of these materials with polyvinyl pyrrolidones or their copolymers. The non-woven fabric, can be composed of polyester or of polyolefine.

For a specially fine filtering, the device can be provided with several layer sequences of membranes and non-woven fabrics. Moreover, above the first membrane also a very coarse-pore non-woven fabric can be arranged with an average pore size of for example 30-200 μm, that retains the micro clots which can clog the pores of the subsequent membrane.

Comparative research of the inventive devices with leukocyte filters, which however contain a thick non-woven fabric or a combination composed of a thin non-woven fabric and a membrane, showed that the leucocyte reduction with the inventive device is 95% when compared with the filters in accordance with the prior art, while the number of thrombocytes and erythrocytes present in the filtrate when compared with filtering devices of the prior art is increased. In particular 81% of the thrombocytes and up to 92% of the erythrocytes can be recovered. During leukocyte filtering with the non-woven fabric to the contrary the recovery rate of thrombocytes is 77% and of the erythrocytes is 88%.

In general, it can be stated that the leukocyte filter in accordance with the present invention can be used very efficiently for the treatment of blood components for transfusion, since it removes leucocytes in an efficient way, while useful blood components are recovered with a high degree and the blood components are activated very little.

The layer sequence can be used for leukocyte depletion of erythrocyte concentrates produced by centrifuging. Moreover, the layer sequence can be used for leukocyte depletion in donor blood directly after erythrocyte-, blood platelets -or blood plasma components by centrifuging. The filtering device can be used also directly in blood donation for filtering out of leukocytes that lead to saving of process time and thereby of cost for the production of blood components.

Further advantages are provided when the membranes and non-woven fabric are steam-sterilizable to exclude contaminations of the blood by the filtering device.

Moreover, the surfaces can be designed charge-free, so that only a small blood activation occurs. The filtration with the inventive device, as in the devices in accordance with the prior art, can be carried out at room temperature without pre-rinsing.

It will be understood that each of the elements described above, or two or more together, may also find a useful application in other types of constructions differing from the types described above.

While the invention has been illustrated and described as embodied in filtering device, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of the invention.

What is claimed as new and desired to be protected by Letters Patent is set forth in the appended claims.

1. A filtering device for filtering out of leukocytes from blood, blood plasma, blood components or protein solutions, comprising a non-woven fabric; and at least one membrane having a thickness of smaller than 150 μm and a pore size smaller than 15 μm.

2. A filtering device as defined in claim 1, wherein the filtering device has a membrane arranged in front of said non-woven fabric and having a thickness smaller than or equal to 150 μm and a pore size greater than or equal to 15 μm.

3. A filtering device as defined in claim 2, wherein the pore size of said at least one membrane in front of said non-woven fabric amounts to 15-40 μm.

4. A filtering device as defined in claim 1, wherein the pore size of said at least one membrane is 4-14 μm.

5. A filtering device as defined in claim 1, wherein said at least one membrane is composed of a hydrophilic material.

6. A filtering device as defined in claim 1, wherein said at least one membrane is composed of a biocompatible material.

7. A filtering device as defined in claim 1, wherein said at least one membrane is composed of a material selected from the group consisting of polysulfone, polyethersulfone, and a composition of a polysulfone or polyethersulfone with materials selected from the group consisting of polyvinylpyrrolidone and its copolymers.

8. A filtering device as defined in claim 1, wherein said non-woven fabric is composed of a material selected from the group consisting of polyester and polyolyfine.

9. A filtering device as defined in claim 1; and further comprising at least one additional membrane located after said non-woven fabric.

10. A filtering device as defined in claim 1; and further comprising at least one additional membrane located after said non-woven fabric, and at least one additional non-woven fabric located after said at least one additional membrane.

11. A filtering device as defined in claim 1; and further comprising a non-woven fabric for filtering out of clots, located above said at least one membrane.

12. A filtering device as defined in claim 1, wherein said at least one membrane and said non-woven fabric are steam-sterilizable.
